(19) United States
(12) Patent Application Publication
(10) Pub. No.: US 2025/0180754 A1
(43) Pub. Date: Jun. 5, 2025

(54) INTEGER AMBIGUITY RESOLUTION (IAR) ENHANCEMENT FOR HIGH-PRECISION GLOBAL NAVIGATION SATELLITE SYSTEM (GNSS) POSITIONING

(71) Applicant: QUALCOMM Incorporated, San Diego, CA (US)

(72) Inventors: Yuxiang PENG, San Jose, CA (US); Min WANG, Tustin, CA (US); Yinghua YANG, Fremont, CA (US); Ning LUO, Cupertino, CA (US); Satya Swaroop YADATI, Bangalore (IN)

(21) Appl. No.: 18/921,395

(22) Filed: Oct. 21, 2024

Related U.S. Application Data
(60) Provisional application No. 63/605,707, filed on Dec. 4, 2023.

(51) Int. Cl. G01S 19/44; G01S 19/29

(52) U.S. Cl. CPC G01S 19/44; G01S 19/29

(57) ABSTRACT

In some implementations, a global navigation satellite system (GNSS) device may obtain measurements where each comprises a respective unresolved ambiguity term. The GNSS device may perform a sequence of IAR procedures using the measurements, wherein performing the sequence of IAR procedures comprises: performing an initial IAR procedure using at least an initial subset of the measurements; performing a second IAR using a second subset of the measurements, wherein performing the second IAR procedure comprises applying one or more masks to the measurements to determine the second subset, and determining that the second IAR procedure resolved at least a threshold number of ambiguity terms. The GNSS device may determine a location estimate of the GNSS device based at least in part on the second IAR procedure.

### RELATED APPLICATIONS

This application claims the benefit of U.S. Provisional Application No. 63/605,707, filed Dec. 4, 2023, entitled “INTEGER AMBIGUITY RESOLUTION (IAR) ENHANCEMENT FOR HIGH-PRECISION GLOBAL NAVIGATION SATELLITE SYSTEM (GNSS) POSITIONING,” which is assigned to the assignee hereof, and incorporated herein in its entirety by reference.

### BACKGROUND

### 1. Field of Disclosure

The present disclosure relates generally to the field of mobile device positioning using radio frequency (RF) signals, and more specifically to global navigation satellite system (GNSS)-based positioning.

### 2. Description of Related Art

The global navigation satellite system (GNSS) is widely used for positioning consumer electronic devices such as smartphones, as well as for positioning vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously driven vehicle is in and may further benefit from sub-meter-level positioning information that enables it to determine where that vehicle is located within the lane.

High-accuracy positioning of a mobile device comprising a GNSS receiver may involve the use of a precise positioning engine (PPE) at the mobile device to generate high-accuracy positioning information based on GNSS measurements and error correction data. The error correction data may be received at the mobile device from a high-accuracy positioning service, such as a precise point positioning (PPP) and/or real-time kinematic (RTK) positioning service. To determine the high-precision location estimate, the PPE may solve for the value of an integer ambiguity of a respective carrier-phase GNSS measurement of a signal from each of a plurality of GNSS satellites. The process by which the integer ambiguity term is solved is typically referred to as integer ambiguity resolution (IAR).

### BRIEF SUMMARY

An example method of integer ambiguity resolution (IAR) for global navigation satellite system (GNSS) positioning, according to this disclosure, may comprise obtaining, at a GNSS device, a plurality of carrier-phase GNSS measurements, wherein each of the plurality of carrier-phase GNSS measurements comprises a respective ambiguity term that is unresolved. The method also may comprise conducting IAR with the GNSS device using the plurality of carrier-phase GNSS measurements, wherein performing a sequence of IAR procedures, wherein performing the sequence of IAR procedures comprises: performing an initial IAR procedure using at least an initial subset of the plurality of carrier-phase GNSS measurements; performing a second IAR procedure using a second subset of the plurality of carrier-phase GNSS measurements, wherein performing the second IAR procedure comprises applying one or more masks to the plurality of carrier-phase GNSS measurements to determine the second subset; and determining that the second IAR procedure resolved the respective ambiguity term of each of at least a threshold number of the plurality of carrier-phase GNSS measurements. The method also may comprise determining, with the GNSS device, a location estimate of the GNSS device based at least in part on the second IAR procedure.

An example GNSS device for performing integer ambiguity resolution (IAR) for global navigation satellite system (GNSS) positioning, according to this disclosure, may comprise one or more GNSS receivers, one or more memories, one or more processors communicatively coupled with the one or more GNSS receivers and the one or more memories, wherein the one or more processors are configured to obtain, via the one or more GNSS receivers, a plurality of carrier-phase GNSS measurements, wherein each of the plurality of carrier-phase GNSS measurements comprises a respective ambiguity term that is unresolved. The one or more processors further may be configured to perform a sequence of IAR procedures, wherein performing the sequence of IAR procedures comprises: performing an initial IAR procedure using at least an initial subset of the plurality of carrier-phase GNSS measurements; performing a second IAR procedure using a second subset of the plurality of carrier-phase GNSS measurements, wherein performing the second IAR procedure comprises applying one or more masks to the plurality of carrier-phase GNSS measurements to determine the second subset; and determining that the second IAR procedure resolved the respective ambiguity term of each of at least a threshold number of the plurality of carrier-phase GNSS measurements. The one or more processors further may be configured to determine a location estimate of the GNSS device based at least in part on the second IAR procedure.

An example apparatus for conducting integer ambiguity resolution (IAR) for global navigation satellite system (GNSS) positioning, according to this disclosure, may comprise means for obtaining a plurality of carrier-phase GNSS measurements, wherein each of the plurality of carrier-phase GNSS measurements comprises a respective ambiguity term that is unresolved. The apparatus further may comprise means for performing a sequence of IAR procedures, wherein the means for performing the sequence of IAR procedures comprises: means for performing an initial IAR procedure using at least an initial subset of the plurality of carrier-phase GNSS measurements; means for performing a second IAR procedure using a second subset of the plurality of carrier-phase GNSS measurements, wherein the means for performing the second IAR procedure comprises means for applying one or more masks to the plurality of carrier-phase GNSS measurements to determine the second subset; and means for determining that the second IAR procedure resolved the respective ambiguity term of each of at least a threshold number of the plurality of carrier-phase GNSS measurements. The apparatus further may comprise means for determining a location estimate of the apparatus based at least in part on the second IAR procedure.

According to this disclosure, an example non-transitory computer-readable medium stores instructions for integer ambiguity resolution (IAR) for global navigation satellite system (GNSS) positioning of a GNSS device, the instructions comprising code for obtaining, a plurality of carrier-phase GNSS measurements, wherein each of the plurality of carrier-phase GNSS measurements comprises a respective ambiguity term that is unresolved. The instructions further may comprise code for performing a sequence of IAR procedures, wherein performing the sequence of IAR procedures comprises: performing an initial IAR procedure using at least an initial subset of the plurality of carrier-phase GNSS measurements; code for performing a second IAR procedure using a second subset of the plurality of carrier-phase GNSS measurements, wherein performing the second IAR procedure comprises applying one or more masks to the plurality of carrier-phase GNSS measurements to determine the second subset; and code for determining that the second IAR procedure resolved the respective ambiguity term of each of at least a threshold number of the plurality of carrier-phase GNSS measurements. The instructions further may comprise code for determining a location estimate of the GNSS device based at least in part on the second IAR procedure.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a global navigation satellite system (GNSS) system, according to an embodiment.

FIG. 2 is a flow diagram illustrating a process by which integer ambiguity resolution (IAR) may be used to update a KF for precise positioning, according to an embodiment.

FIG. 3 is a flow diagram illustrating a process by which IAR performance may be enhanced, according to an embodiment.

FIG. 4 includes tables that show the experimental results of applying the carrier-to-noise power density (CNO) mask method described herein.

FIG. 5 includes a table that shows additional experimental results for the usage of CNO masks in ascending and descending manners.

FIG. 6 includes a table that shows values before and after the application of satellite vehicle satellite vehicles (SV) elevation masks in the manner herein, according to an embodiment.

FIG. 7 is a flow diagram of a method of IAR for GNSS positioning, according to an embodiment.

FIG. 8 is a block diagram of an embodiment of a GNSS device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples, in which one or more aspects of the disclosure may be implemented, are described below, other examples may be used, and various modifications may be made, without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

A “space vehicle” (SV) as referred to herein, relates to an object that is capable of transmitting signals to receivers on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. An electronic device having a GNSS receiver may be referred to herein as a “GNSS device.” GNSS devices may include, but are not limited to, cell phones, smart phones, laptops, tablets, vehicles, Internet of Thing (IoT) devices, drones, surveying equipment, navigational equipment, and the like. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, the location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As used herein, the terms “position” and “location” are used interchangeably. Further, terms such as “position determination,” “position fix,” “location estimate,” “estimated location,” “location fix,” and the like are also used interchangeably herein with regard to GNSS-based positioning to refer to an estimated position of a GNSS device. The position or location may be a two-dimensional position, e.g., with regard to a two-dimensional map, or a three-dimensional position.

As noted, a high-accuracy (e.g., “high-precision,” or “precise”) position estimate of a GNSS device (e.g., having an accuracy on the order of decimeters or even centimeters) may be determined with a precise positioning engine (PPE), which may be executed by the GNSS device. Real-time kinematic (RTK), precise point positioning (PPP), and PPP-RTK (a hybrid of PPP and RTK) are three common techniques of precise positioning, all of which utilize carrier phase (CP) GNSS measurements. To determine the high-precision location estimate, the PPE may solve for the value of an integer ambiguity of a respective carrier-phase GNSS measurement of a signal from each of a plurality of GNSS satellites. The process by which the integer ambiguity term is solved is typically referred to as integer ambiguity resolution (IAR). A less-accurate position solution prior to the determination of the integer ambiguity terms may be referred to as a “float solution,” mandate more-accurate position solution subsequent to the determination of the integer ambiguity terms may be referred to as a “fixed solution.”

The least-squares ambiguity decorrelation adjustment (LAMBDA) is a common IAR algorithm. For LAMBDA-based IAR, the input includes a set of float CP ambiguities and the corresponding CP ambiguity covariance (i.e., uncertainty), and the outputs include the two best sets of integer ambiguity solutions if solvable. A ratio test based on an empirical look-up table is conducted to verify if the IAR solution can be passed as a standard checking. With respect to the embodiments described herein below, the ratio test (which is not limited to LAMBDA-based IAR) can be used to verify whether the results of IAR are additionally accurate enough to result in a fixed solution.

It can be noted, however, that the ratio test (or other IAR results checking) is not always accurate. It may be typical for a certain number of fixed solutions (also referred to herein as “fixes”) to be incorrect. That is, an incorrectly solved ambiguity term can result in an inaccurate “wrong fix.” For purposes of this disclosure, a “wrong fix” may be defined as any fixed solution for which the horizontal error (e.g.) is greater than 50 cm (with respect to a ground truth (GT) position with a horizontal uncertainty of position error (HEPE) equal to or less than 10 cm). Further, as used herein, the term “fixing rate” may be defined as the ratio of the number of IAR fixed solution epochs over all solution epochs. A “wrong fix rate” may then be defined as the ratio of the number of epochs claimed as wrong fix over the number of epochs for all fixed solutions.

Traditional IAR techniques typically require a trade-off between a fixing rate and a wrong fix rate. That is, according to traditional IAR techniques, adjusting the techniques to increase a fixing rate will typically result in an increased wrong fix rate. Further, reducing the wrong fix rate will typically reduce the overall fixing rate.

Embodiments described herein address these and other issues by performing IAR more than once utilizing one or more masks of cascading values (e.g., successively ascending or descending), which can both increase in overall fixing rate while decreasing a corresponding wrong fix rate. The types of masks, or filters, applied to GNSS measurements may include a carrier-to-noise power density (CNO) mask, a satellite vehicle (SV) elevation mask, a prefit-residual mask, an ambiguity covariance mask, or any combination thereof. As described herein below, the optimal use of different mask types may involve different types of cascading values (e.g., ascending or descending).

Particular aspects of the subject matter described in this disclosure can be implemented to realize one or more of the following potential advantages. In some examples, by utilizing one or more GNSS measurement masks in a cascading manner, the described techniques can be used to perform high-precision GNSS fixes with a higher fixing rate and/or lower wrong fix rate than traditional techniques. Depending on a device's capabilities, a device may implement IAR using different types of masks. Additional benefits will be apparent to a person of ordinary skill in the art, based on the information provided herein. Embodiments are provided in detail below, after a review of relevant technology.

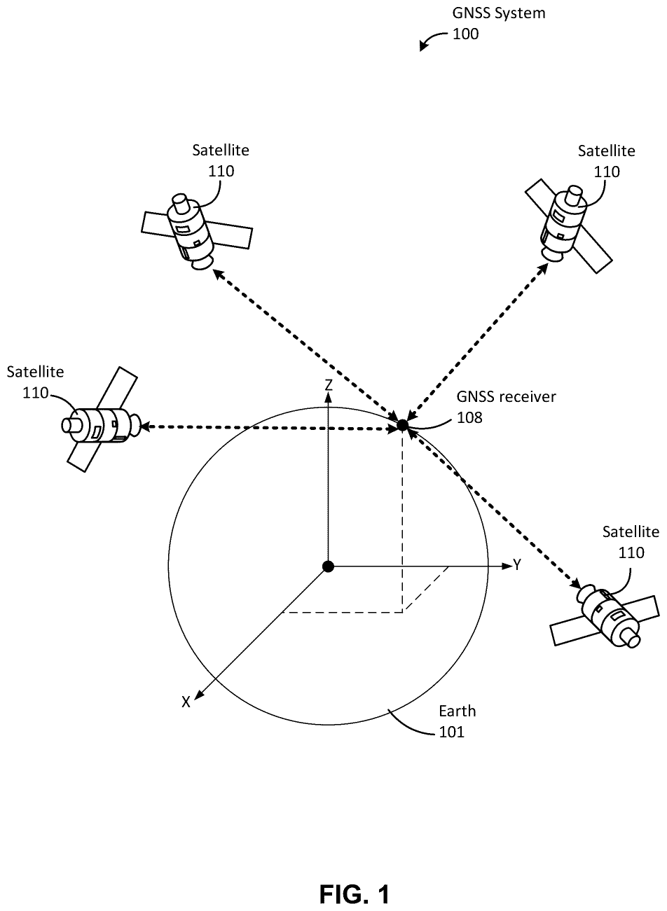

FIG. 1 is a simplified diagram of a GNSS system 100, provided to illustrate how GNSS is generally used to determine an accurate location of a GNSS receiver 108 on Earth 101. Put generally, the GNSS system 100 enables an accurate GNSS position fix of the GNSS receiver 108, which receives RF signals from GNSS satellites 110 (also known as “satellite vehicles” or SVs) from one or more GNSS constellations. The types of GNSS receiver 108 used may vary, depending on the application. In some embodiments, for instance, the GNSS receiver 108 may comprise a standalone device or component incorporated into another device. In some embodiments, the GNSS receiver 108 may be integrated into industrial or commercial equipment, such as survey equipment, Internet of Things (IoT) devices, etc.

It will be understood that the diagram provided in FIG. 1 is greatly simplified. In practice, there may be dozens of satellites 110 in a given GNSS constellation, and there are many different types of GNSS systems. GNSS systems include Global Positioning System (GPS), Galileo, GLONASS, or BeiDou Navigation Satellite System (BDS). Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on multilateration, which is a method of determining position by measuring distances to points at known coordinates. In general, the determination of the position of a GNSS receiver 108 in three dimensions may rely on a determination of the distance between the GNSS receiver 108 and four or more satellites 110. As illustrated, 3D coordinates may be based on a coordinate system (e.g., Cartesian coordinates in the format of X, Y, and Z; geographic coordinates in the format of latitude, longitude, and altitude; etc.) centered at the earth's center of mass. A distance between each satellite 110 and the GNSS receiver 108 may be determined using precise measurements made by the GNSS receiver 108 of a difference in time from when an RF signal is transmitted from the respective satellite 110 to when it is received at the GNSS receiver 108. To help ensure accuracy, not only does the GNSS receiver 108 need to make an accurate determination of when the respective signal from each satellite 110 is received, but many additional factors need to be considered and accounted for. These factors include, for example, clock differences at the GNSS receiver 108 and satellite 110 (e.g., clock bias), a precise location of each satellite 110 at the time of transmission (e.g., as determined by the broadcast ephemeris), the impact of atmospheric distortion (e.g., ionospheric and tropospheric delays), and the like.

To perform a traditional GNSS position fix, the GNSS receiver 108 can use code-based positioning to determine its distance to each satellite 110 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 110, the GNSS receiver 108 can then determine a position fix for its location. This position fix may be determined, for example, by a Standalone Positioning Engine (SPE) executed by one or more processors of the GNSS receiver 108. However, code-based positioning is relatively inaccurate and, without error correction, and is subject to many of the previously described errors. Even so, code-based GNSS positioning can provide a positioning accuracy for the GNSS receiver 108 on the order of meters.

More accurate carrier-based positioning is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric error sources) in the carrier-based ranging of satellites 110 observed by the GNSS receiver 108 can be mitigated or canceled. This error correction may be based, for example, on similar carrier-based ranging of the satellites 110 using a highly accurate GNSS receiver at the base station at a known location, in which case these measurements and the base station's location can be provided to the GNSS receiver 108 for error correction.

This more accurate carrier-based position fix may be determined, for example, by a Precise Positioning Engine (PPE) executed by one or more processors of the GNSS receiver 108. More specifically, in addition to the information provided to an SPE, the PPE may use base station GNSS measurement information, and additional correction information, such as troposphere and ionosphere error correction, to provide a high-accuracy, carrier-based position fix. As used herein, a “high-precision” or “precision positioning” position fix may refer to a position determined by a PPE using carrier-based ranging. Several GNSS techniques can be adopted in PPE, such as Differential GNSS (DGNSS), Real-Time Kinematic (RTK), Precise Point Positioning (PPP), and hybrid RTK and PPP (PPP-RTK), and may provide a sub-meter accuracy (e.g., on the order of decimeters or centimeters). (An SPE and/or PPE may be referred to herein as a GNSS positioning engine and may be incorporated into a broader positioning engine that uses other (non-GNSS) positioning sources.) A position fix may comprise a position-velocity-time (PVT) position, in which the position and velocity of a GNSS receiver at a given time, is determined. A high-precision PVT position fix made by a PPE may utilize three types of measurements of GNSS satellite signals: pseudorange (PR), carrier phase (CP), and Doppler (DP).

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 110 may be members of a single satellite constellation, i.e., a group of satellites that are part of a GNSS system, e.g., controlled by a common entity such as a government, and orbiting in complementary orbits to facilitate determining positions of entities around the world. One or more of the satellites 110 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

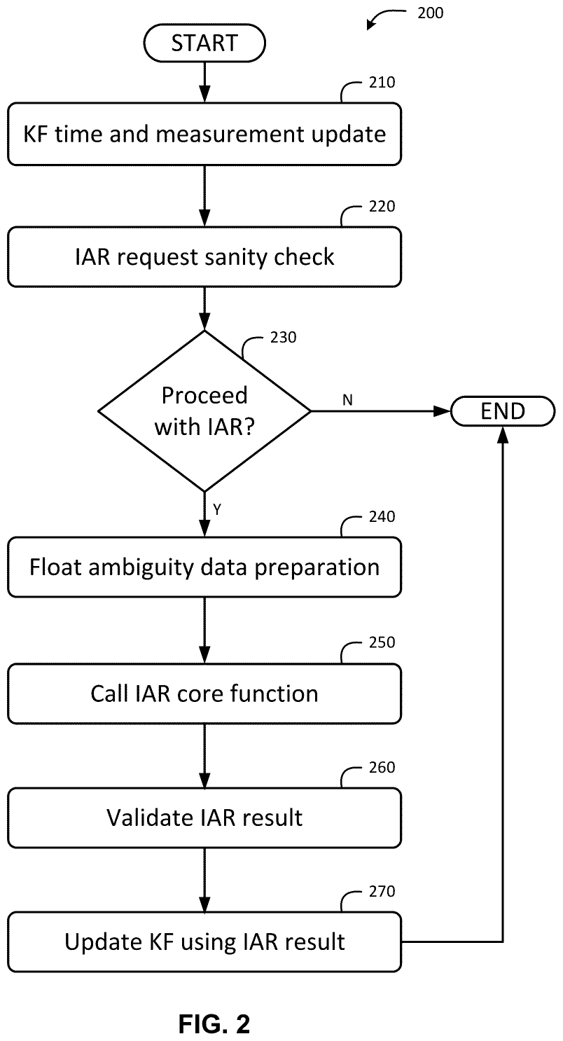

As noted, a fixed solution for a high-accuracy carrier-based position estimate of a GNSS device involves IAR, which may be used in conjunction with updating a Kalman filter (KF) of a PPE. A process of utilizing IAR in updating the KF is illustrated in FIG. 2, which is described below.

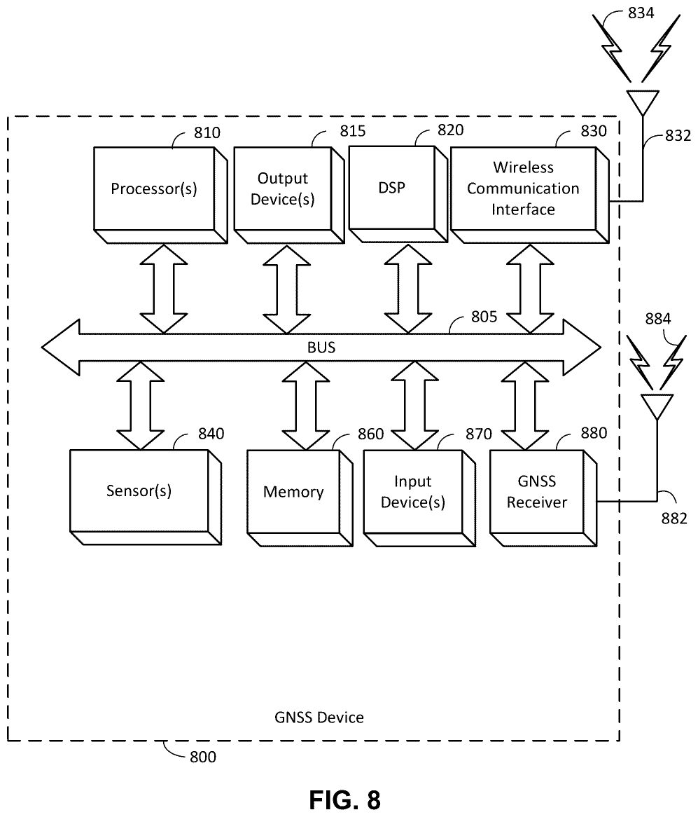

FIG. 2 is a flow diagram 200 illustrating a process by which IAR may be used to update a KF for precise positioning, according to an embodiment. This general process may be reflective of traditional techniques, although embodiments may implement a modified float ambiguity data preparation (block 240), as described below. Further, embodiments are not necessarily limited to the particular KF updating process illustrated in FIG. 2. The process of FIG. 2 may be incorporated into a larger process by which a PPE determines a precise position of a GNSS device. This determination may occur every epoch, which may be 1 Hz, as an example (although various embodiments may have update rates that are higher and/or lower than 1 Hz). The process in FIG. 2 may be executed as a function by or in conjunction with a PPE, which may be executed using hardware and/or software components of a GNSS device. Example components of a GNSS device are described below with respect to FIG. 8.

The process may begin at block 210, in which a time and measurement update for a KF is performed. The time and measurement update may utilize new GNSS measurements obtained by the GNSS device, including pseudorange (PR), carrier phase (CP), Doppler (DP), carrier-to-noise power density (CNO), and time. These new GNSS measurements may the made for each GNSS signal measured by the GNSS device. Each satellite may generate one or more GNSS signals (e.g., some satellites may generate more than one GNSS signal by transmitting on more than one GNSS frequency band).

At block 220, the functionality includes a “sanity check” before performing IAR (e.g., sending a request to an IAR function). More specifically, this sanity check may comprise checking to determine if the GNSS device has the prerequisite data to perform IAR. For example, if there are not enough new GNSS measurements to perform IAR (e.g., fewer than four GNSS measurements), then the sanity check fails. Additionally or alternatively, if the float accuracy is already good enough for a particular positioning application (e.g., on the order of meters, which may be sufficient for certain application needs), then the sanity check fails. A failure of the sanity check performed at block 220 can result in a determination at block 230 not to proceed with IAR. Otherwise, the process proceeds with the functionality at block 240, in which the float ambiguity data preparation is performed. This data preparation can include masking (or filtering) GNSS measurements to ensure a proper fixing rate (in view of the trade-off with the wrong fixed rate, as previously described). An example of data preparation can include filtering GNSS measurements to ensure geometric quality.

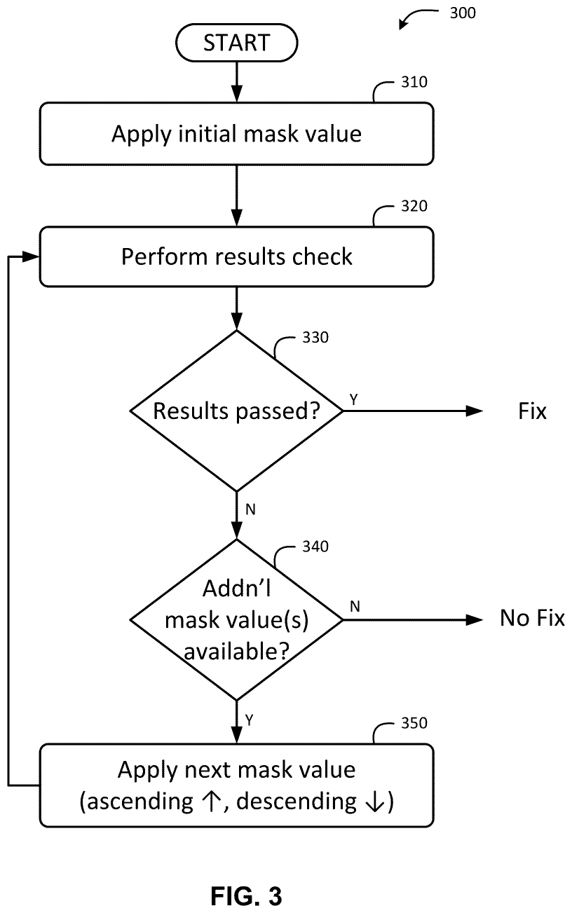

As noted, embodiments may perform modified float ambiguity data preparation, masking (or filtering) GNSS measurements to help increase a fixing rate and/or reduce a wrong fix rate. This modified float ambiguity data preparation is described in more detail hereafter, with respect to FIG. 3.

At block 250, the IAR is performed (e.g., a call is made to the IAR core function). More specifically, IAR is performed using the data prepared in the float ambiguity data preparation of block 240. As noted, LAMBDA is an example IAR algorithm that may be used, although there are various other IAR algorithms that may be used, depending on desired functionality. Once the IAR result is determined (e.g., by the IAR core function), the process may then validate an IAR result (e.g., also described herein as a “results check”) as indicated at block 260. (As previously noted, this may comprise a ratio test.) After passing validation, the KF is updated using the IAR result, as indicated at block 270. (Additional details regarding validation, including what may be done if initial validation does not pass, are provided below.)

It can be noted that embodiments may employ various operations that are not necessarily illustrated in FIG. 2. For example, if the IAR results are insufficient to update a KF, the process may be aborted. This may include, for instance, the IAR resulting in no integer ambiguity fixes (or fewer than a threshold number of integer ambiguity fixes) and/or the results of IAR failing validation at block 260.

According to embodiments, certain aspects of the process of diagram 200 can be enhanced to help increase accuracy. As noted, embodiments may perform IAR more than once utilizing one or more masks of cascading values in a manner that results in high-precision GNSS fixes with a higher fixing rate and/or lower wrong fix rate than traditional techniques. Additional details are described below with respect to FIG. 3.

FIG. 3 is a flow diagram 300 illustrating a process by which IAR performance may be enhanced, according to some embodiments. It can be noted that the process of diagram 300 may be used in conjunction with the process of diagram 200 in FIG. 2. In particular, the process of flow diagram 300 implements a process by which one or more masks of cascading values may be used in the float ambiguity data preparation of block 240 in FIG. 2.

The process of flow diagram 300 may begin with the functionality at block 310, in which an initial mask value may be applied. As noted, a mask may comprise a filter applied to GNSS measurements, reducing the amount of GNSS measurements used for IAR, based on the type of mask. As noted, mask types can include a carrier-to-noise power density (CNO) mask, a satellite vehicle (SV) elevation mask, a prefit-residual mask, an ambiguity covariance mask, or any combination thereof. It can be further noted that, according to some embodiments, the application of an initial mask value at block 310 may be performed after there is a failure of IAR to resolve a threshold number of ambiguity terms.

At block 320, the functionality comprises performing the results check. This can include, for example, a preliminary IAR result validation (e.g., ratio test, similar to the functionality at block 260 of FIG. 2). As shown by block 330, if the results pass (e.g., a threshold number of ambiguity terms are resolved) this can result in a “fix” outcome, in which case the KF filter may be updated with the IAR results, as indicated at block 270 of FIG. 2. Otherwise, if results do not pass, a determination is made of whether additional mask values are available, as indicated at block 340. If additional mask values are available, the process can continue by applying a subsequent mask value, as indicated at block 350, and the procedure can revert to a results check at block 320, with the IAR results of the newly-applied value. Otherwise, if no additional mask values are available (e.g., the process has cycled through all available mask values), the process can result in a “no fix” outcome, in which case the PPE remains in a float (rather than a fixed) solution for at least another epoch.

The process of cycling through mask values by repeating the functionality at blocks 320-350 can be done such that value “cascading” occurs. That is, successive mask values may increase (e.g., “ascending” mask values) or decrease (e.g., “ascending” mask values). The optimization of the type of cascading values (e.g., ascending or descending) and the values themselves to result in an increased fixing rate and/or decreased wrong fix rate may depend on the type of mask used. Mask types are discussed in more detail below. Further, some embodiments may utilize multiple masks, while others may use only a single mask. This can be based, for example, on whether the GNSS device has sufficient resources to apply multiple masks.

Experimental results have shown that a cascading approach using ascending mask values for a CNO mask can be beneficial. In some cases, due to the higher multipath on carrier phase measurements, the ambiguity term in lower CNO measurements may not have the integer property. Including such an ambiguity term in the IAR (e.g., LAMBDA search) can lead to a failure in the ratio test and a “no fix” result. By applying the CNO mask, the non-integer ambiguity term can be effectively excluded, which can help increase the fixing rate and quality.

As an example, a cascading approach to applying CNO masks for IAR may be as follows:
Initially, a LAMBDA search of all ambiguity candidates may be performed without using a CNO mask. (Alternatively, another IAR algorithm may be performed.)
If the previous operation fails to pass the ratio test (e.g., corresponding to a failure of results passing at block 330 of FIG. 3), a CNO mask of 35 dBHz may be applied to the ambiguity candidate (e.g., corresponding to applying a “next” mask value at block 350 of FIG. 3) to only search a subset of GNSS measurements that meet this CNO mask criterion.
If the previous operation fails to pass the ratio test the process can be repeated using, a CNO mask having a higher value of 37.5 dBHz.
If the previous operation fails to pass the ratio test the process can be repeated using, a CNO mask having a higher value of 40 dBHz.

Again, the values (e.g., including relative values or “step” size) and the number of CNO masks may vary, depending on desired functionality and other implementation considerations. Further, it can be noted that the benefits of utilizing partial IAR searches as described herein may be limited to a purely float ambiguity mode. That is, the process above may be applied when no ambiguity terms have been resolved. Further, the process above may be stopped when a threshold number of ambiguity terms have been resolved. As example, the process may stop when more than five ambiguities have been resolved using CNO mask.

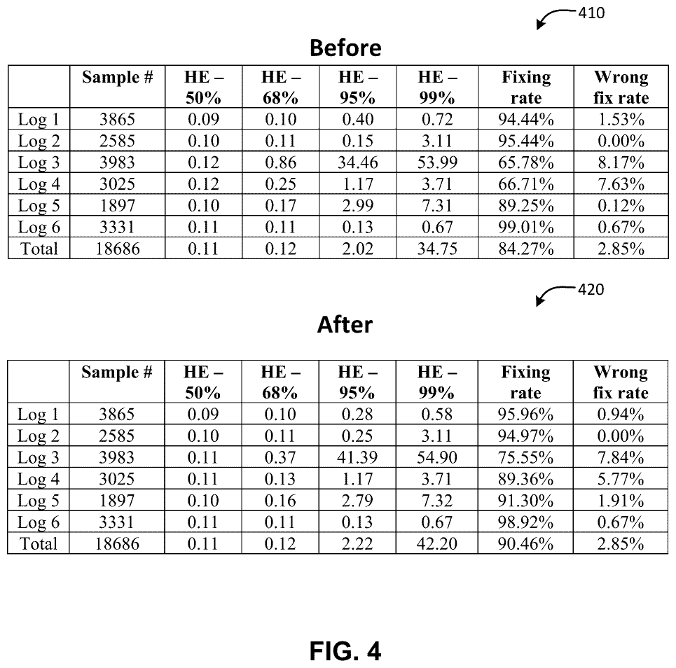

FIG. 4 includes tables 410 and 420, which show experimental results of applying the CNO mask method described above. The “before” table 410 shows horizontal error values (in meters), fixing rate, and wrong fix rate for six data sets (Logs 1-6), using traditional techniques in which the process of applying cascading CNO masks as described above is not applied. The “after” table 420 shows corresponding values when the process of applying cascading CNO masks described above is applied to the same data sets. As can be seen, the use of cascading CNO masks in the manner described above results in a higher fixing percentage (approximately 6% higher than “before” values) and a lower wrong fix rate in many of the data sets.

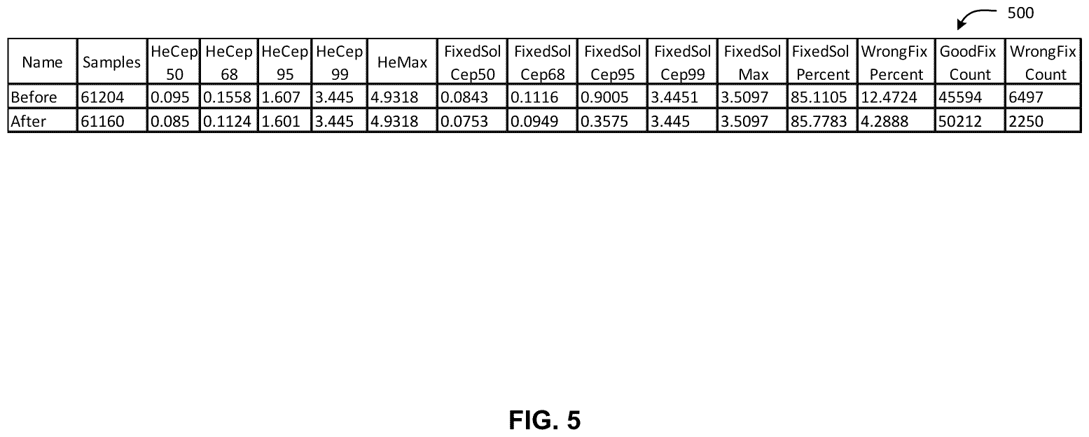

FIG. 5 includes table 500 that shows additional experimental results for the usage of CNO masks in ascending and descending manners. More particularly, the experimental results shown in table 500 compare descending and ascending CNO masks. The “before” row shows values for a process in which descending values of CNO masks were used for a given data set. Specifically, ascending mask values {47.5, 45.0, 42.5, 40.0, 37.5, 35.0, 0.0} dBHz were used. In contrast, the “after” row shows values for the process in which ascending values {0.0, 35.0, 37.5, 40.0, 42.5, 45.0, 47.5} dBHz were used on the same data set. As can be seen in table 500, cascading order can impact performance. The ascending values in the “after” row result in a higher fixing percentage and a lower wrong fix rate than descending values. As such, some embodiments may use ascending CNO masks to optimize IAR.

According to some embodiments, SV elevation masks may additionally or alternatively be used. Statistically, GNSS signal multipath occurs at higher rates for lower elevation SVs, which can result in a non-integer carrier phase property of those SVs. Thus, including those lower elevation ambiguity terms in IAR may lead to a decrease in the fixing rate and/or an increase in the wrong fix rate. With this in mind, applying SV elevation masks may help improve overall performance.

An example cascading approach to applying SV elevation masks for IAR may use ascending values {30, 35, 40, 45, 50, 55, 60) degrees. The process may be as follows:
Initially, an SV elevation mask of 30° may be applied to the ambiguity candidate to only search the subset that meets this criterion.
If the previous operation fails to pass the ratio test (e.g., corresponding to a failure of results passing at block 330 of FIG. 3), an SV elevation mask of 35° may be applied.
If the previous operation fails to pass the ratio test, the process can be repeated using an SV elevation mask of 40°.
The process may continue to use successive elevation masks of increasing (ascending) value if successive ratio tests fail.

Various aspects of the use of SV elevation masks may mirror those related to the use of CNO masks, described previously. For example, the values (e.g., including the steps as increments) and the number of SV elevation masks may vary depending on desired functionality and other implementation considerations. Further, SV elevation masks may be applied when no ambiguity terms have been resolved. Moreover, the process above may be stopped when a threshold number of ambiguity terms have been resolved.

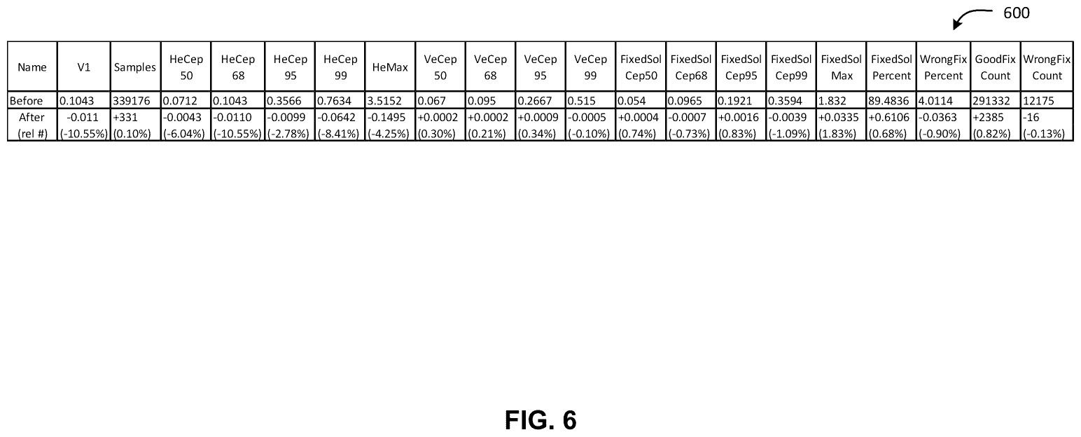

FIG. 6 includes a table 600 that shows values before and after the application of SV elevation masks in the manner described above, in conjunction with the use of CNO masks as previously applied. Here, the “before” row illustrates various positioning values, including a fixing rate (“FixedSolPercent”) and wrong fix rate (“WrongFixPercent”), using only CNO masks come in the ascending cascading manner described above. The “after” row shows similar values after SV elevation masks are also applied, as previously described, with relative numbers (rel #) included in parentheses. As can be seen, the additional use of SV elevation masks in the manner described above results in an increase in the fixing rate of 0.68% and a decrease in the wrong fix rate of 0.13%.

The principles described above may be extended to other mask types, which may be used in addition or as an alternative to the masks described above. For example, a pre-fit-residual mask may be used in which cascading values are descending (e.g., 30 m, 25 m, 20 m, 15 m, and 10 m). Moreover, refit-residual mask values and step sizes can be designed for both carrier phase and pseudorange GNSS measurements. Additionally or alternatively, a flow ambiguity covariance mask may the implied in which cascading values are also descending (e.g., 60 cm, 40 cm, and 20 cm). Again, the values and step sizes may vary, depending on desired functionality and other implementation considerations.

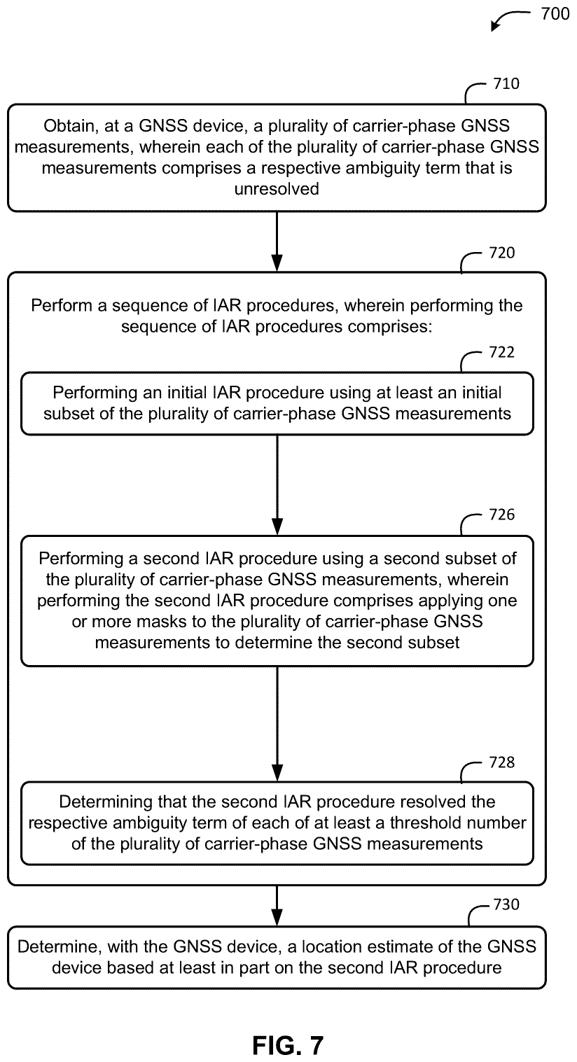

FIG. 7 is a flow diagram of a method 700 of IAR for GNSS positioning, according to an embodiment. Aspects of the method 700 may correspond to the functionality described in the embodiments above, including the functionality illustrated in FIG. 3. In particular, the method 700 may be viewed as a way in which cascading masks may be applied for float ambiguity data preparation. The functionality illustrated in one or more of the blocks shown in FIG. 7 may be performed by or in conjunction with a positioning engine, such as a PPE. As such, means and/or structure for executing some or all of the functionality of the method 700 may comprise the same means and/or structure for executing the positioning engine, which can include hardware and/or software components of a GNSS device. Example components of a GNSS device are illustrated in FIG. 8, which is described in more detail below.

At block 710, the functionality comprises obtaining, at a GNSS device, a plurality of carrier-phase GNSS measurements, wherein each of the plurality of carrier-phase GNSS measurements comprises a respective ambiguity term that is unresolved. Obtaining carrier phrase (CP) GNSS measurements may be performed, for example, by a GNSS receiver of the GNSS device. As noted, carrier phase measurements may be obtained in addition to pseudorange (PR) and Doppler (DP) to enable a PPE to determine a high-precision PVT solution.

Means for performing functionality at block 710 may comprise a bus 805, one or more processors 810, DSP 820, wireless communication interface 830, memory 860, GNSS receiver 880, and/or other components of a GNSS device, as illustrated in FIG. 8.

At block 720, the functionality performing a sequence of IAR procedures. As indicated by the functionality of blocks 722, 726, and 728, this includes executing multiple operations. At block 722, the functionality comprises performing an initial IAR procedure using at least an initial subset of the plurality of carrier-phase GNSS measurements. As noted in the embodiments above, this “at least an initial subset” may or may not include utilizing a mask having an initial value. In either case, the functionality at block 726 may be performed, which includes performing a second IAR procedure using a second subset of the plurality of carrier-phase GNSS measurements, wherein performing the second IAR procedure comprises applying one or more masks to the plurality of carrier-phase GNSS measurements to determine the second subset. As noted in the embodiments above, performing the second IAR procedure may be in response to a determination that the initial IAR procedure failed to resolve the respective ambiguity term of each of at least a threshold number of the plurality of carrier-phase GNSS measurements. According to some embodiments and/or in some instances, the second IAR procedure may comprise a final IAR procedure. The determination that the initial IAR procedure failed to resolve the respective ambiguity term of each of at least a threshold number of the plurality of carrier-phase GNSS measurements may correspond, for example, to the functionality at block 320 and 330 in FIG. 3. The functionality at block 726 can be followed by the functionality at block 728, in which is determined that the second IAR procedure resolved the respective ambiguity term of each of at least a threshold number of the plurality of carrier-phase GNSS measurements (e.g., the threshold number of the plurality of carrier-phase GNSS measurements noted above). The operations at blocks 726 and 728 may correspond to a second (e.g., successful/final) cycle through the functionality shown at blocks 350, 320, and 330 of FIG. 3. As indicated herein, embodiments herein using cascading mask values for IAR procedures may be particularly helpful when no ambiguity terms have been resolved. Thus, according to some embodiments, performing a sequence of IAR procedures in the manner shown in block 720 may be responsive to a determination that none of the respective ambiguity terms for any of the plurality of carrier-phase GNSS measurements are resolved.

As described in the embodiments above, the method of block 720 may include one or more additional features. According to some embodiments, the one or more masks may comprise a carrier-to-noise power density (CNO) mask, a satellite vehicle (SV) elevation mask, a prefit-residual mask, an ambiguity covariance mask, or any combination thereof. Additionally or alternatively, there may be one or more intervening cycles between the initial IAR procedure and second IAR procedure in which different mask values are applied. Moreover, the initial IAR procedure may include the use of a mask, and each of the one or more masks applied in the second IAR procedure may have a respective second value. As such, according to some embodiments, performing the initial IAR procedure may comprise applying the one or more masks to the plurality of carrier-phase GNSS measurements to determine the initial subset, wherein each of the one or more masks has a respective initial value different than the respective second value. Such embodiments may further include, subsequent to performing the initial IAR procedure and prior to performing the second IAR procedure, performing an intermediary IAR procedure using an intermediary subset of the plurality of carrier-phase GNSS measurements, wherein performing the intermediary IAR procedure comprises applying the one or more masks to the plurality of carrier-phase GNSS measurements to determine the intermediary subset, wherein each of the one or more masks has a respective intermediary value. As noted, cascading (successive) mask values may be ascending or descending. Thus, according to some embodiments, for each of the one or more masks the respective initial value is greater than the respective intermediary value and the respective intermediary value is greater than the respective second value, or the respective initial value is less than the respective intermediary value and the respective intermediary value is less than the respective second value. Further, according to some embodiments, the one or more masks comprises a CNO mask, and the respective initial value of the CNO mask is less than the respective intermediary value of the CNO mask and the respective intermediary value of the CNO mask is less than the respective second value of the CNO mask.

Means for performing functionality at block 720 may comprise a bus 805, one or more processors 810, DSP 820, wireless communication interface 830, memory 860, GNSS receiver 880, and/or other components of a GNSS device, as illustrated in FIG. 8.

At block 730, the functionality comprises determining, with the GNSS device, a location estimate of the GNSS device based at least in part on the second IAR procedure. As indicated above, the determination of the location estimate may comprise updating a Kalman filter with IAR results (e.g., the functionality of block 270 of FIG. 2). The location estimate may then be provided by a positioning engine of the GNSS device to another component, device, or use interface. For example, some embodiments of the method 700 may further comprise outputting the location estimate with the GNSS device, wherein the outputting comprises providing an indication of the location estimate at a user interface of the GNSS device, providing an indication of the location estimate to an application or operating system of the GNSS device, sending an indication of the location estimate from a GNSS receiver of the GNSS device to an application processor of the GNSS device, sending an indication of the location estimate from the GNSS device to another device, or any combination thereof.

Means for performing functionality at block 730 may comprise a bus 805, one or more processors 810, DSP 820, wireless communication interface 830, memory 860, GNSS receiver 880, and/or other components of a GNSS device, as illustrated in FIG. 8.

FIG. 8 is a block diagram of an embodiment of a GNSS device 800, which can be utilized as described herein above (e.g., in association with FIGS. 1-7). In some embodiments, GNSS device 800 may implement a PPE, can perform the operations illustrated in FIGS. 2 and 3, and/or perform the method 700 of FIG. 7. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The GNSS device 800 is shown comprising hardware elements that can be electrically coupled via a bus 805 (or may otherwise be in communication, as appropriate). The hardware elements may include a processor(s) 810, which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with base stations of a network, for example, via eNBs, gNBs, ng-eNBs, access points, and/or other access node types, and/or other network components, computer systems, and/or any other electronic devices communicatively coupled with base stations, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of integer ambiguity resolution (IAR) for global navigation satellite system (GNSS) positioning, the method comprising: obtaining, at a GNSS device, a plurality of carrier-phase GNSS measurements, wherein each of the plurality of carrier-phase GNSS measurements comprises a respective ambiguity term that is unresolved; performing a sequence of IAR procedures, wherein performing the sequence of IAR procedures comprises: performing an initial IAR using at least an initial subset of the plurality of carrier-phase GNSS measurements; performing a second IAR procedure using a second subset of the plurality of carrier-phase GNSS measurements, wherein performing the second IAR procedure comprises applying one or more masks to the plurality of carrier-phase GNSS measurements to determine the second subset; and determining that the second IAR procedure resolved the respective ambiguity term of each of at least the threshold number of the plurality of carrier-phase GNSS measurements; and determining, with the GNSS device, a location estimate of the GNSS device based at least in part on the second IAR procedure.

Clause 2: The method of clause 1, wherein the one or more masks comprise: a carrier-to-noise power density (CNO) mask, a satellite vehicle (SV) elevation mask, a prefit-residual mask, an ambiguity covariance mask, or any combination thereof.

Clause 3: The method of any one of clauses 1-2 wherein each of the one or more masks applied in the second IAR procedure has a respective second value, and wherein performing the initial IAR procedure comprises applying the one or more masks to the plurality of carrier-phase GNSS measurements to determine the initial subset, wherein each of the one or more masks has a respective initial value different than the respective second value.

Clause 4: The method of clause 3 further comprising, subsequent to performing the initial IAR procedure and prior to performing the second IAR procedure, performing an intermediary IAR procedure using an intermediary subset of the plurality of carrier-phase GNSS measurements, wherein performing the intermediary IAR procedure comprises applying the one or more masks to the plurality of carrier-phase GNSS measurements to determine the intermediary subset, wherein each of the one or more masks has a respective intermediary value.

Clause 5: The method of clause 4 wherein, for each of the one or more masks the respective initial value is greater than the respective intermediary value and the respective intermediary value is greater than the respective second value, or the respective initial value is less than the respective intermediary value and the respective intermediary value is less than the respective second value.

Clause 6: The method of clause 5 wherein the one or more masks comprises a CNO mask, and the respective initial value of the CNO mask is less than the respective intermediary value of the CNO mask and the respective intermediary value of the CNO mask is less than the respective second value of the CNO mask.

Clause 7: The method of any one of clauses 1-6 wherein performing the sequence of IAR procedures is responsive to a determination that none of the respective ambiguity terms for any of the plurality of carrier-phase GNSS measurements are resolved.

Clause 8: The method of any one of clauses 1-7 further comprising outputting the location estimate with the GNSS device, wherein the outputting comprises: providing an indication of the location estimate at a user interface of the GNSS device, providing an indication of the location estimate to an application or operating system of the GNSS device, sending an indication of the location estimate from a GNSS receiver of the GNSS device to an application processor of the GNSS device, sending an indication of the location estimate from the GNSS device to another device, or any combination thereof.

Clause 9: A GNSS device for performing integer ambiguity resolution (IAR) for global navigation satellite system (GNSS) positioning, the GNSS device comprising: one or more GNSS receivers; one or more memories; and one or more processors communicatively coupled with the one or more GNSS receivers and the one or more memories, wherein the one or more processors are configured to: obtain, via the one or more GNSS receivers, a plurality of carrier-phase GNSS measurements, wherein each of the plurality of carrier-phase GNSS measurements comprises a respective ambiguity term that is unresolved; perform a sequence of IAR procedures, wherein performing the sequence of IAR procedures comprises: performing an initial IAR procedure using at least an initial subset of the plurality of carrier-phase GNSS measurements; performing a second IAR procedure using a second subset of the plurality of carrier-phase GNSS measurements, wherein performing the second IAR procedure comprises applying one or more masks to the plurality of carrier-phase GNSS measurements to determine the second subset; and determining that the second IAR procedure resolved the respective ambiguity term of each of at least the threshold number of the plurality of carrier-phase GNSS measurements; and determine a location estimate of the GNSS device based at least in part on the second IAR procedure.

Clause 10: The GNSS device of clause 9, wherein the one or more masks comprise: a carrier-to-noise power density (CNO) mask, a satellite vehicle (SV) elevation mask, a prefit-residual mask, an ambiguity covariance mask, or any combination thereof.

Clause 11: The GNSS device of any one of clauses 9-10 wherein each of the one or more masks applied in the second IAR procedure has a respective second value, and wherein, to perform the initial IAR procedure, the one or more processors are configured to apply the one or more masks to the plurality of carrier-phase GNSS measurements to determine the initial subset, wherein each of the one or more masks has a respective initial value different than the respective second value.

Clause 12: The GNSS device of clause 11 wherein the one or more processors are further configured to, subsequent to performing the initial IAR procedure and prior to performing the second IAR procedure, perform an intermediary IAR procedure using an intermediary subset of the plurality of carrier-phase GNSS measurements, wherein, to perform the intermediary IAR procedure, the one or more processors are configured to apply the one or more masks to the plurality of carrier-phase GNSS measurements to determine the intermediary subset, wherein each of the one or more masks has a respective intermediary value.

Clause 13: The GNSS device of clause 12 wherein, for each of the one or more masks the respective initial value is greater than the respective intermediary value and the respective intermediary value is greater than the respective second value, or the respective initial value is less than the respective intermediary value and the respective intermediary value is less than the respective second value.

Clause 14: The GNSS device of clause 13 wherein the one or more masks comprises a CNO mask, and the respective initial value of the CNO mask is less than the respective intermediary value of the CNO mask and the respective intermediary value of the CNO mask is less than the respective second value of the CNO mask.

Clause 15: The GNSS device of any one of clauses 9-14 wherein the one or more processors are configured to perform a sequence of IAR procedures responsive to a determination that none of the respective ambiguity terms for any of the plurality of carrier-phase GNSS measurements are resolved.

Clause 16: The GNSS device of any one of clauses 9-15 wherein the one or more processors are further configured to output the location estimate with the GNSS device, wherein, to output the location estimate, the one or more processors are configured to: provide an indication of the location estimate at a user interface of the GNSS device, provide an indication of the location estimate to an application or operating system of the GNSS device, send an indication of the location estimate from a GNSS receiver of the GNSS device to an application processor of the GNSS device, send an indication of the location estimate from the GNSS device to another device, or any combination thereof.

Clause 17: An apparatus for conducting integer ambiguity resolution (IAR) for global navigation satellite system (GNSS) positioning, the apparatus comprising: means for obtaining a plurality of carrier-phase GNSS measurements, wherein each of the plurality of carrier-phase GNSS measurements comprises a respective ambiguity term that is unresolved; means for performing a sequence of IAR procedures, wherein the means for performing the sequence of IAR procedures comprises: means for performing an initial IAR procedure using at least an initial subset of the plurality of carrier-phase GNSS measurements; means for performing a second IAR procedure using a second subset of the plurality of carrier-phase GNSS measurements, wherein the means for performing the second IAR procedure comprises means for applying one or more masks to the plurality of carrier-phase GNSS measurements to determine the second subset; and means for determining that the second IAR procedure resolved the respective ambiguity term of each of at least the threshold number of the plurality of carrier-phase GNSS measurements; and means for determining a location estimate of the apparatus based at least in part on the second IAR procedure.

Clause 18: The apparatus of clause 17, wherein the one or more masks comprise: a carrier-to-noise power density (CNO) mask, a satellite vehicle (SV) elevation mask, a prefit-residual mask, an ambiguity covariance mask, or any combination thereof.

Clause 19: The apparatus of any one of clauses 17-18 wherein each of the one or more masks applied in the second IAR procedure has a respective second value, and wherein the means for performing the initial IAR procedure comprises means for applying the one or more masks to the plurality of carrier-phase GNSS measurements to determine the initial subset, wherein each of the one or more masks has a respective initial value different than the respective second value.

Clause 20: The apparatus of clause 19 further comprising means for performing an intermediary IAR procedure using an intermediary subset of the plurality of carrier-phase GNSS measurements subsequent to performing the initial IAR procedure and prior to performing the second IAR procedure, wherein the means for performing the intermediary IAR procedure comprises means for applying the one or more masks to the plurality of carrier-phase GNSS measurements to determine the intermediary subset, wherein each of the one or more masks has a respective intermediary value.

Clause 21: The apparatus of clause 20 wherein, for each of the one or more masks the respective initial value is greater than the respective intermediary value and the respective intermediary value is greater than the respective second value, or the respective initial value is less than the respective intermediary value and the respective intermediary value is less than the respective second value.

Clause 22: The apparatus of clause 21 wherein the one or more masks comprises a CNO mask, and the respective initial value of the CNO mask is less than the respective intermediary value of the CNO mask and the respective intermediary value of the CNO mask is less than the respective second value of the CNO mask.

Clause 23: The apparatus of any one of clauses 17-22 wherein the means for performing the sequence of IAR procedures is configured to perform the sequence of IAR procedures responsive to a determination that none of the respective ambiguity terms for any of the plurality of carrier-phase GNSS measurements are resolved.

Clause 24: The apparatus of any one of clauses 17-23 further comprising means for outputting the location estimate, wherein the means for outputting comprises: means for providing an indication of the location estimate at a user interface, means for providing an indication of the location estimate to an application or operating system, means for sending an indication of the location estimate from a GNSS receiver to an application processor, means for sending an indication of the location estimate from to device separate from the apparatus, or any combination thereof.

Clause 25: A non-transitory computer-readable medium storing instructions for integer ambiguity resolution (IAR) for global navigation satellite system (GNSS) positioning of a GNSS device, the instructions comprising code for: obtaining, a plurality of carrier-phase GNSS measurements, wherein each of the plurality of carrier-phase GNSS measurements comprises a respective ambiguity term that is unresolved; performing a sequence of IAR procedures, wherein performing the sequence of IAR procedures comprises: performing an initial IAR procedure using at least an initial subset of the plurality of carrier-phase GNSS measurements performing a second IAR procedure using a second subset of the plurality of carrier-phase GNSS measurements, wherein performing the second IAR procedure comprises applying one or more masks to the plurality of carrier-phase GNSS measurements to determine the second subset; and determining that the second IAR procedure resolved the respective ambiguity term of each of at least the threshold number of the plurality of carrier-phase GNSS measurements; and determining a location estimate of the GNSS device based at least in part on the second IAR procedure.

Clause 26: The computer-readable medium of clause 25, wherein the one or more masks comprise: a carrier-to-noise power density (CNO) mask, a satellite vehicle (SV) elevation mask, a prefit-residual mask, an ambiguity covariance mask, or any combination thereof.

Clause 27: The computer-readable medium of any one of clauses 25-26 wherein each of the one or more masks applied in the second IAR procedure has a respective second value, and wherein the code for performing the initial IAR procedure comprises code for applying the one or more masks to the plurality of carrier-phase GNSS measurements to determine the initial subset, wherein each of the one or more masks has a respective initial value different than the respective second value.

Clause 28: The computer-readable medium of clause 27 wherein the instructions further comprise code for, subsequent to performing the initial IAR procedure and prior to performing the second IAR procedure, performing an intermediary IAR procedure using an intermediary subset of the plurality of carrier-phase GNSS measurements, wherein the code for performing the intermediary IAR procedure comprises code for applying the one or more masks to the plurality of carrier-phase GNSS measurements to determine the intermediary subset, wherein each of the one or more masks has a respective intermediary value.

Clause 29: The computer-readable medium of clause 28 wherein, for each of the one or more masks the respective initial value is greater than the respective intermediary value and the respective intermediary value is greater than the respective second value, or the respective initial value is less than the respective intermediary value and the respective intermediary value is less than the respective second value.

Clause 30: The computer-readable medium of clause 29 wherein the one or more masks comprises a CNO mask, and the respective initial value of the CNO mask is less than the respective intermediary value of the CNO mask and the respective intermediary value of the CNO mask is less than the respective second value of the CNO mask.

Clause 31: The computer-readable medium of any one of clauses 25-30 wherein performing the sequence of IAR procedures is responsive to a determination that none of the respective ambiguity terms for any of the plurality of carrier-phase GNSS measurements are resolved.

Clause 32: The computer-readable medium of any one of clauses 25-31 wherein the instructions further comprise code for outputting the location estimate with the GNSS device, wherein the code for outputting comprises: code for providing an indication of the location estimate at a user interface of the GNSS device, code for providing an indication of the location estimate to an application or operating system of the GNSS device, code for sending an indication of the location estimate from a GNSS receiver of the GNSS device to an application processor of the GNSS device, code for sending an indication of the location estimate from the GNSS device to another device, or any combination thereof.

What is claimed is:

1. A method of integer ambiguity resolution (IAR) for global navigation satellite system (GNSS) positioning, the method comprising:
obtaining, at a GNSS device, a plurality of carrier-phase GNSS measurements, wherein each of the plurality of carrier-phase GNSS measurements comprises a respective ambiguity term that is unresolved;
performing a sequence of IAR procedures, wherein performing the sequence of IAR procedures comprises:
performing an initial IAR procedure using at least an initial subset of the plurality of carrier-phase GNSS measurements;
performing a second IAR procedure using a second subset of the plurality of carrier-phase GNSS measurements, wherein performing the second IAR procedure comprises applying one or more masks to the plurality of carrier-phase GNSS measurements to determine the second subset; and
determining that the second IAR procedure resolved the respective ambiguity term of each of at least a threshold number of the plurality of carrier-phase GNSS measurements; and
determining, with the GNSS device, a location estimate of the GNSS device based at least in part on the second IAR procedure.

2. The method of claim 1, wherein the one or more masks comprise:
a carrier-to-noise power density (CNO) mask,
a satellite vehicle (SV) elevation mask,
a prefit-residual mask,
an ambiguity covariance mask, or
any combination thereof.

3. The method of claim 1, wherein each of the one or more masks applied in the second IAR procedure has a respective second value, and wherein performing the initial IAR procedure comprises applying the one or more masks to the plurality of carrier-phase GNSS measurements to determine the initial subset, wherein each of the one or more masks has a respective initial value different than the respective second value.

4. The method of claim 3, further comprising, subsequent to performing the initial IAR procedure and prior to performing the second IAR procedure, performing an intermediary IAR procedure using an intermediary subset of the plurality of carrier-phase GNSS measurements, wherein performing the intermediary IAR procedure comprises applying the one or more masks to the plurality of carrier-phase GNSS measurements to determine the intermediary subset, wherein each of the one or more masks has a respective intermediary value.

5. The method of claim 4, wherein, for each of the one or more masks:
the respective initial value is greater than the respective intermediary value and the respective intermediary value is greater than the respective second value, or
the respective initial value is less than the respective intermediary value and the respective intermediary value is less than the respective second value.

6. The method of claim 5, wherein the one or more masks comprises a CNO mask, and the respective initial value of the CNO mask is less than the respective intermediary value of the CNO mask and the respective intermediary value of the CNO mask is less than the respective second value of the CNO mask.

7. The method of claim 1, wherein performing the sequence of IAR procedures is responsive to a determination that none of the respective ambiguity terms for any of the plurality of carrier-phase GNSS measurements are resolved.

8. The method of claim 1, further comprising outputting the location estimate with the GNSS device, wherein the outputting comprises:
providing an indication of the location estimate at a user interface of the GNSS device,
providing an indication of the location estimate to an application or operating system of the GNSS device,
sending an indication of the location estimate from a GNSS receiver of the GNSS device to an application processor of the GNSS device,
sending an indication of the location estimate from the GNSS device to another device, or
any combination thereof.

9. A GNSS device for performing integer ambiguity resolution (IAR) for global navigation satellite system (GNSS) positioning, the GNSS device comprising:
one or more GNSS receivers;
one or more memories; and
one or more processors communicatively coupled with the one or more GNSS receivers and the one or more memories, wherein the one or more processors are configured to:
obtain, via the one or more GNSS receivers, a plurality of carrier-phase GNSS measurements, wherein each of the plurality of carrier-phase GNSS measurements comprises a respective ambiguity term that is unresolved;
perform a sequence of IAR procedures, wherein performing the sequence of IAR procedures comprises:
performing an initial IAR procedure using at least an initial subset of the plurality of carrier-phase GNSS measurements;
performing a second IAR procedure using a second subset of the plurality of carrier-phase GNSS measurements, wherein performing the second IAR procedure comprises applying one or more masks to the plurality of carrier-phase GNSS measurements to determine the second subset; and
determining that the second IAR procedure resolved the respective ambiguity term of each of at least a threshold number of the plurality of carrier-phase GNSS measurements; and
determine a location estimate of the GNSS device based at least in part on the second IAR procedure.

10. The GNSS device of claim 9, wherein the one or more masks comprise:
a carrier-to-noise power density (CNO) mask,
a satellite vehicle (SV) elevation mask,
a prefit-residual mask,
an ambiguity covariance mask, or
any combination thereof.

11. The GNSS device of claim 9, wherein each of the one or more masks applied in the second IAR procedure has a respective second value, and wherein, to perform the initial IAR procedure, the one or more processors are configured to apply the one or more masks to the plurality of carrier-phase GNSS measurements to determine the initial subset, wherein each of the one or more masks has a respective initial value different than the respective second value.

12. The GNSS device of claim 11, wherein the one or more processors are further configured to, subsequent to performing the initial IAR procedure and prior to performing the second IAR procedure, perform an intermediary IAR procedure using an intermediary subset of the plurality of carrier-phase GNSS measurements, wherein, to perform the intermediary IAR procedure, the one or more processors are configured to apply the one or more masks to the plurality of carrier-phase GNSS measurements to determine the intermediary subset, wherein each of the one or more masks has a respective intermediary value.

13. The GNSS device of claim 12, wherein, for each of the one or more masks:
the respective initial value is greater than the respective intermediary value and the respective intermediary value is greater than the respective second value, or
the respective initial value is less than the respective intermediary value and the respective intermediary value is less than the respective second value.

14. The GNSS device of claim 13, wherein the one or more masks comprises a CNO mask, and the respective initial value of the CNO mask is less than the respective intermediary value of the CNO mask and the respective intermediary value of the CNO mask is less than the respective second value of the CNO mask.

15. The GNSS device of claim 9, wherein the one or more processors are configured to perform a sequence of IAR procedures responsive to a determination that none of the respective ambiguity terms for any of the plurality of carrier-phase GNSS measurements are resolved.

16. The GNSS device of claim 9, wherein the one or more processors are further configured to output the location estimate with the GNSS device, wherein, to output the location estimate, the one or more processors are configured to:
provide an indication of the location estimate at a user interface of the GNSS device,
provide an indication of the location estimate to an application or operating system of the GNSS device,
send an indication of the location estimate from a GNSS receiver of the GNSS device to an application processor of the GNSS device,
send an indication of the location estimate from the GNSS device to another device, or
any combination thereof.

17. An apparatus for conducting integer ambiguity resolution (IAR) for global navigation satellite system (GNSS) positioning, the apparatus comprising:
means for obtaining a plurality of carrier-phase GNSS measurements, wherein each of the plurality of carrier-phase GNSS measurements comprises a respective ambiguity term that is unresolved;
means for performing a sequence of IAR procedures, wherein the means for performing the sequence of IAR procedures comprises:
means for performing an initial IAR procedure using at least an initial subset of the plurality of carrier-phase GNSS measurements;
means for performing a second IAR procedure using a second subset of the plurality of carrier-phase GNSS measurements, wherein the means for performing the second IAR procedure comprises means for applying one or more masks to the plurality of carrier-phase GNSS measurements to determine the second subset; and
means for determining that the second IAR procedure resolved the respective ambiguity term of each of at least a threshold number of the plurality of carrier-phase GNSS measurements; and
means for determining a location estimate of the apparatus based at least in part on the second IAR procedure.

18. The apparatus of claim 17, wherein the one or more masks comprise:
a carrier-to-noise power density (CNO) mask,
a satellite vehicle (SV) elevation mask,
a prefit-residual mask,
an ambiguity covariance mask, or
any combination thereof.

19. The apparatus of claim 17, wherein each of the one or more masks applied in the second IAR procedure has a respective second value, and wherein the means for performing the initial IAR procedure comprises means for applying the one or more masks to the plurality of carrier-phase GNSS measurements to determine the initial subset, wherein each of the one or more masks has a respective initial value different than the respective second value.

20. The apparatus of claim 19, further comprising means for performing an intermediary IAR procedure using an intermediary subset of the plurality of carrier-phase GNSS measurements subsequent to performing the initial IAR procedure and prior to performing the second IAR procedure, wherein the means for performing the intermediary IAR procedure comprises means for applying the one or more masks to the plurality of carrier-phase GNSS measurements to determine the intermediary subset, wherein each of the one or more masks has a respective intermediary value.
